(19) United States
(12) Patent Application Publication
(10) Pub. No.: US 2019/0294531 A1
(43) Pub. Date: Sep. 26, 2019

(54) AUTOMATED SOFTWARE DEPLOYMENT AND TESTING BASED ON CODE MODIFICATION AND TEST FAILURE CORRELATION

(71) Applicant: CA, Inc., New York, NY (US)

(72) Inventors: Yaron Avisror, Kfar-Saba (IL); Uri Scheiner, Sunnyvale, CA (US); Ofer Yaniv, Tel Aviv (IL)

(21) Appl. No.: 16/050,389

(22) Filed: Jul. 31, 2018

Related U.S. Application Data
(63) Continuation-in-part of application No. 15/935,712, filed on Mar. 26, 2018.

(51) Int. Cl. G06F 11/36; G06F 8/60

(52) U.S. Cl. CPC G06F 11/3684; G06F 11/3688; G06F 8/60; G06F 11/3676; G06F 11/3664; G06F 11/3692

(57) ABSTRACT

A computer system is configured to provide automated testing of a second build combination based on retrieving, from a data store, test result data indicating execution of a plurality of test cases for a first build combination that includes a software artifact that has been modified relative to a previous build combination. A subset of the test cases is associated with the software artifact based on the test result data, where the subset includes test cases that failed the execution of the test cases for the first build combination. Automated testing is executed for a second build combination including the software artifact, where the automated testing includes the subset of the test cases. The second build combination may be subsequent and non-consecutive to the first build combination.

### CROSS-REFERENCE TO RELATED APPLICATIONS

This application is a continuation-in-part of U.S. patent application Ser. No. 15/935,712 entitled “AUTOMATED SOFTWARE DEPLOYMENT AND TESTING” filed Mar. 26, 2018, the entire contents of which are incorporated by reference herein in its entirety.

### BACKGROUND

The present disclosure relates in general to the field of computer development, and more specifically, to software deployment in computing systems.

Modern software systems often include multiple program or application servers working together to accomplish a task or deliver a result. An enterprise can maintain several such systems. Further, development times for new software releases are shrinking, allowing releases to be deployed to update or supplement a system on an ever-increasing basis. Some enterprises release, patch, or otherwise modify software code dozens of times per week. Further, some enterprises can maintain multiple servers to host and/or test their software applications. As updates to software and new software are developed, testing of the software can involve coordinating across multiple testing phases, sets of test cases, and machines in the test environment.

### BRIEF SUMMARY

Some embodiments of the present disclosure are directed to operations performed by a computer system including a processor and a memory coupled to the processor. The memory includes computer readable program code embodied therein that, when executed by the processor, causes the processor to perform operations described herein. The operations include retrieving, from a data store, test result data indicating execution of a plurality of test cases for a first build combination, where the first build combination includes a software artifact that has been modified relative to a previous build combination. A subset of the test cases is associated with the software artifact based on the test result data, where the subset includes test cases that failed the execution of the test cases for the first build combination. Automated testing is executed for a second build combination including the software artifact, where the automated testing includes the subset of the test cases. The second build combination may be subsequent and non-consecutive to the first build combination.

### BRIEF DESCRIPTION OF THE DRAWINGS

Other features of embodiments of the present disclosure will be more readily understood from the following detailed description of specific embodiments thereof when read in conjunction with the accompanying drawings, in which:

FIG. 1A is a simplified schematic diagram of an example computing environment according to some embodiments of the present disclosure;

FIG. 1B is a simplified block diagram illustrating example build combinations according to some embodiments of the present disclosure;

FIG. 2 is a simplified block diagram of an example computing system according to some embodiments of the present disclosure;

FIG. 3 is a simplified block diagram illustrating an example automated test deployment model according to some embodiments of the present disclosure;

FIG. 4A is a simplified schematic diagram illustrating an example automated provisioning of computing systems in a test environment based on code change analysis according to some embodiments of the present disclosure;

FIG. 4B is a simplified block diagram illustrating an example automated deployment of a build combination based on code change analysis according to some embodiments of the present disclosure;

FIG. 4C is graphical representation illustrating performance data resulting from an example automated test execution based on code change analysis according to some embodiments of the present disclosure;

FIG. 5 is a screenshot of a graphical user interface illustrating an example automated definition and selection of test cases based on code change analysis in a continuous delivery test deployment cycle according to some embodiments of the present disclosure;

FIG. 6 is a simplified block diagram illustrating an example automated risk score calculation and association based on code change analysis in a continuous delivery test deployment cycle according to some embodiments of the present disclosure;

FIG. 7 is a screenshot of a graphical user interface illustrating example risk metrics based on code complexity and historical activity information generated from code change analysis according to some embodiments of the present disclosure;

FIG. 8 is a simplified flowchart illustrating example operations in connection with automated test deployment according to some embodiments of the present disclosure;

FIG. 9 is a simplified flowchart illustrating example operations in connection with automated risk assessment of software in a test environment according to some embodiments of the present disclosure;

FIGS. 10A and 10B are simplified flowcharts illustrating example operations in connection with automated test case selection according to some embodiments of the present disclosure;

FIGS. 11A and 11B are simplified block diagrams illustrating an example automated test case selection model according to some embodiments of the present disclosure.

### DETAILED DESCRIPTION OF EMBODIMENTS

Various embodiments will be described more fully hereinafter with reference to the accompanying drawings. Other embodiments may take many different forms and should not be construed as limited to the embodiments set forth herein. Like numbers refer to like elements throughout.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

In software deployments on servers, “production” may refer to deployment of a version of the software on one or more production servers in a production environment, to be used by customers or other end-users. Other versions of the deployed software may be installed on one or more servers in a test environment, development environment, and/or disaster recovery environment. As used herein, a server may refer to a physical or virtual computer server, including computing instances or virtual machines (VMs) that may be provisioned (deployed or instantiated).

Various embodiments of the present disclosure may arise from realization that efficiency in automated software test execution may be improved and processing requirements of one or more computer servers in a test environment may be reduced by automatically adapting (e.g., limiting and/or prioritizing) testing based on identification of software artifacts that include changes to a software build and/or risks associated therewith. For example, in continuous delivery (CD), software may be built, deployed, and tested in short cycles, such that the software can be reliably released at any time. Code may be compiled and packaged by a build server whenever a change is committed to a source repository, then tested by various techniques (which may include automated and/or manual testing) before it can be marked as releasable. Continuous delivery may help reduce the cost, time, and/or risk of delivering changes by allowing for more frequent and incremental updates to software. An update process may replace an earlier version of all or part of a software build with a newer build. Version tracking systems help find and install updates to software. In some continuous delivery environments and/or software as a service systems, differently-configured versions of the system can exist simultaneously for different internal or external customers (known as a multi-tenant architecture), or even be gradually rolled out in parallel to different groups of customers.

Some embodiments of the present disclosure may be directed to improvements to automated software test deployment by dynamically adding and/or removing test assets (including test data, resources, etc.) to/from a test environment (and/or test cases to/from a test cycle) based on detection or identification of software artifacts that include modifications relative to one or more previous versions of the software. As used herein, software artifacts (or “artifacts”) can refer to files in the form of computer readable program code that can provide a software application, such as a web application, search engine, etc., and/or features thereof. As such, identification of software artifacts as described herein may include identification of the files or binary packages themselves, as well as classes, methods, and/or data structures thereof at the source code level. A software build may refer to the result of a process of converting source code files into software artifacts, which may be stored in a computer readable storage medium (e.g., a build server) and deployed to a computing system (e.g., one or more servers of a computing environment). A build combination refers to the set of software artifacts for a particular deployment. A build combination may include one or more software artifacts that are modified (e.g., new or changed) relative to one or more previous build combinations, for instance, to add features to and/or correct defects; however, such modifications may affect interoperability with one another.

Testing of the software artifacts may be used to ensure proper functionality of a build combination prior to release. Regression testing is a type of software testing that ensures that previously developed and tested software still performs the same way after it is changed or interfaced with other software in a particular iteration. Changes may include software enhancements, patches, configuration changes, etc. Automated testing may be implemented as a stage of a release pipeline in which a software application is developed, built, deployed, and tested for release in frequent cycles. For example, in continuous delivery, a release pipeline may refer to a set of validations through which the build combination should pass on its way to release.

According to embodiments of the present disclosure, automatically identifying software artifacts including modifications relative to previous builds combinations and using this information to pare down automated test execution based on the modifications (e.g., by selecting only a subset of the test assets and/or test cases that are relevant to test new and/or changed software artifacts) may reduce computer processing requirements, increase speed of test operation or test cycle execution, reduce risk by increasing the potential to fail earlier in the validation stages, and improve overall efficiency in the test stage of the release pipeline. In some embodiments, paring-down of the automated test execution may be further based on respective risk scores or other risk assessments associated with the modified software artifacts. Paring-down of the testing may be implemented by automated provisioning of one or more computer servers in a software test environment to remove one or more test assets from an existing configuration/attributes of a test environment, and/or by removing/prioritizing one or more test cases of a test cycle in automated test execution for a build combination.

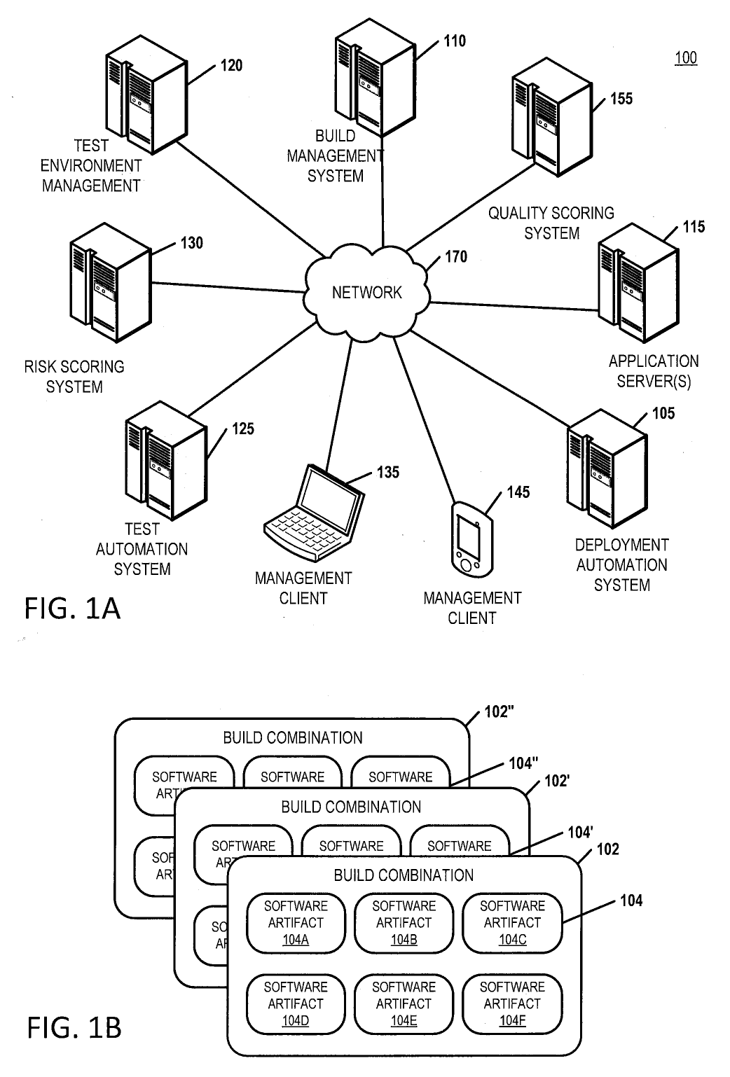

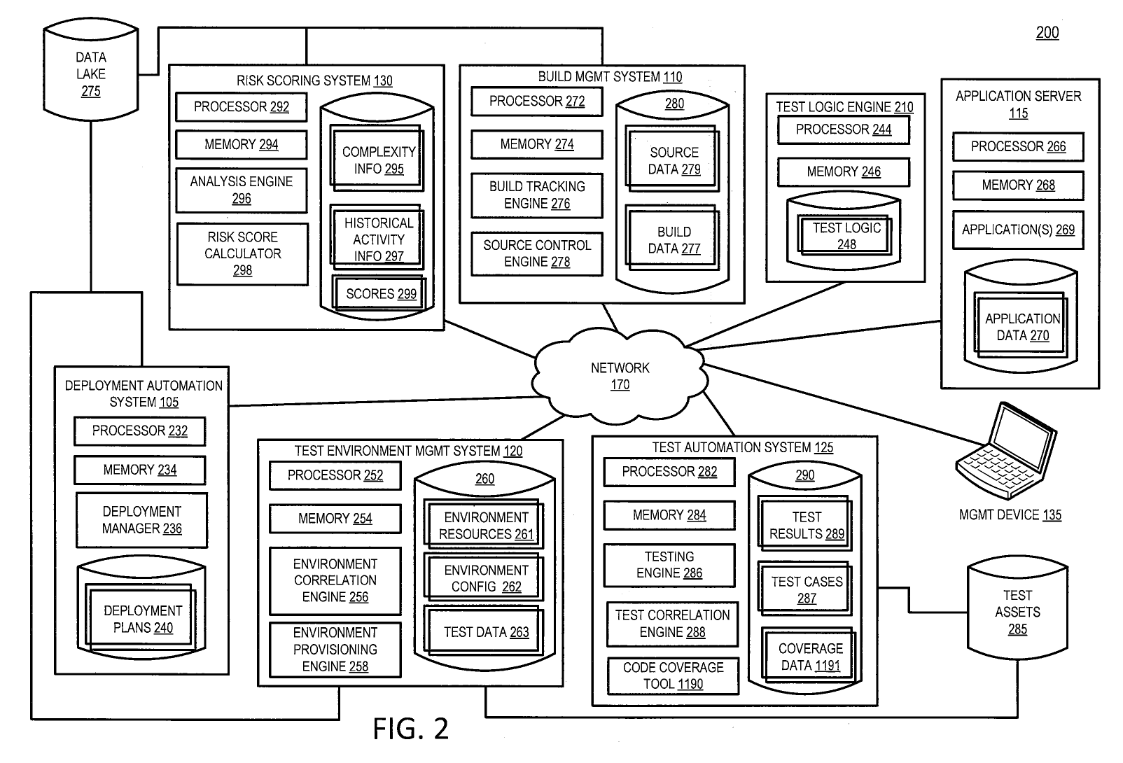

FIG. 1A is a simplified schematic diagram illustrating an example computing environment 100 according to embodiments described herein. FIG. 1B is a simplified block diagram illustrating examples of build combinations 102, 102′, 102″ that may be managed by the computing environment 100 of FIG. 1A. Referring to FIGS. 1A and 1B, the computing environment 100 may include a deployment automation system 105, one or more build management systems (e.g., system 110), one or more application server systems (e.g., system 115), a test environment management system (e.g., system 120), and a test automation system (e.g., system 125) in communication with one or more networks (e.g., network 170). Network 170 may include any conventional, public and/or private, real and/or virtual, wired and/or wireless network, including the Internet. The computing environment 100 may further include a risk scoring system (e.g., system 130), and a quality scoring system (e.g., system 155) in some embodiments.

One or more development server systems, among other example pre- or post-production systems, can also be provided in communication with the network 170. The development servers may be used to generate one or more pieces of software, embodied by one or more software artifacts 104, 104′, 104″, from a source. The source of the software artifacts 104, 104′, 104″ may be maintained in one or more source servers, which may be part of the build management system 110 in some embodiments. The build management system may be configured to organize pieces of software, and their underlying software artifacts 104, 104′, 104″, into build combinations 102, 102′, 102″. The build combinations 102, 102′, 102″ may represent respective collections or sets of the software artifacts 104, 104′, 104″. Embodiments will be described herein with reference to deployment of the software artifacts 104A-104F (generally referred to as artifacts 104) of build combination 102 as a build or version under test, and with reference to build combinations 102′, 102″ as previously-deployed build combinations for convenience rather than limitation. The current and previous build combinations 102, 102′, 102″ include respective combinations of stories, features, and defect fixes based on the software artifacts 104, 104′, 104″ included therein. As described herein, a software artifact 104 that includes or comprises a modification may refer to a software artifact that is new or changed relative to one or more corresponding software artifacts 104′, 104″ of a previous build combination 102′, 102″.

Deployment automation system 105 can make use of data that describes the features of a deployment of a given build combination 102, 102′, 102″ embodied by one or more software artifacts 104, 104′, 104″, from the artifacts' source(s) (e.g., system 110) onto one or more particular target systems (e.g., system 115) that have been provisioned for production, testing, development, etc. The data can be provided by a variety of sources and can include information defined by users and/or computing systems. The data can be processed by the deployment automation server 105 to generate a deployment plan or specification that can then be read by the deployment automation server 105 to perform the deployment of the software artifacts onto one or more target systems (such as the test environments described herein) in an automated manner, that is, without the further intervention of a user.

Software artifacts 104 that are to be deployed within a test environment can be hosted by a single source server or multiple different, distributed servers, among other implementations. Deployment of software artifacts 104 of a build combination 102 can involve the distribution of the artifacts 104 from such sources (e.g., system 110) to their intended destinations (e.g., one or more application servers of system 115) over one or more networks 170, responsive to control or instruction by the deployment automation system 105. The application servers 115 may include web servers, virtualized systems, database systems, mainframe systems and other examples. The application servers 115 may execute and/or otherwise make available the software artifacts 104 of the release combination 102. In some embodiments, the application servers 115 may be accessed by one or more management computing devices 135, 145.

The test environment management system 120 is configured to perform automated provisioning of one or more servers (e.g., servers of system 115) of a test environment for the build combination 102. Server provisioning may refer to a set of actions to configure a server with access to appropriate systems, data, and software based on resource requirements, such that the server is ready for desired operation. Typical tasks when provisioning a server are: select a server from a pool of available servers, load the appropriate software (operating system, device drivers, middleware, and applications), and/or otherwise appropriately configure the server to find associated network and storage resources. Test assets for use in provisioning the servers may be maintained in one or more databases that are included in or otherwise accessible to the test environment management system 120). The test assets may include resources, configuration attributes, and/or data that may be used to test the software artifacts 104 of the selected build combination 102.

The provisioned server(s) can communicate with the test automation system 125 in connection with a post-deployment test of the software artifacts 104 of the build combination 102. Test automation system 125 can implement automated test execution based on a suite of test cases to simulate inputs of one or more users or client systems to the deployed build combination 102, and observation of the responses or results. In some cases, the deployed build combination 102 can respond to the inputs by generating additional requests or calls to other systems. Interactions with these other systems can be provided by generating a virtualization of other systems. Providing virtual services allows the build combination 102 under test to interact with a virtualized representation of a software service that might not otherwise be readily available for testing or training purposes (e.g., due to constraints associated with that software service). Different types of testing may utilize different test environments, some or all of which may be virtualized to allow serial or parallel testing to take place. Upon test failure, the test automation system 125 can identify the faulty software artifacts from the test platforms, notify the responsible developer(s), and provide detailed test and result logs. The test automation system 125 may thus validate the operation of the build combination 102. Moreover, if all tests pass, the test automation system 125 or a continuous integration framework controlling the tests can automatically promote the build combination 102 to a next stage or environment, such as a subsequent phase of a test cycle or release cycle.

Computing environment 100 can further include one or more management computing devices (e.g., clients 135, 145) that can be used to interface with resources of deployment automation system 105, target servers 115, test environment management system 120, test automation system 125, etc. For instance, users can utilize computing devices 135, 145 to select or request build combinations for deployment, and schedule or launch an automated deployment to a test environment through an interface provided in connection with the deployment automation system, among other examples. The computing environment 100 can also include one or more assessment or scoring systems (e.g., risk scoring system 130, quality scoring system 155) that can be used to generate and associate indicators of risk and/or quality with one or more build combinations 102, 102′, 102″ and/or individual software artifacts 104, 104′, 104″ thereof. The generated risk scores and/or quality scores may be used for automated selection of test assets for the test environment and/or test cases for the test operations based on modifications to the software artifacts of a build combination, as described in greater detail herein.

In general, “servers,” “clients,” “computing devices,” “network elements,” “database systems,” “user devices,” and “systems,” etc. (e.g., 105, 110, 115, 120, 125, 135, 145, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 120, 125, 135, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, a deployment automation system 105, source server system 110, test automation system 125, application server system 115, test environment management system 120, or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1A is described as containing or being associated with a plurality of elements, not all elements illustrated within computing environment 100 of FIG. 1A may be utilized in each implementation of the present disclosure. Additionally, one or more of the elements described in connection with the examples of FIG. 1A may be located external to computing environment 100, while in other instances, certain elements may be included within or as a portion of one or more of the other described elements, as well as other elements not described in the illustrated implementation. Further, elements illustrated in FIG. 1A may be combined with other components, as well as used for alternative or additional purposes in addition to those purposes described herein.

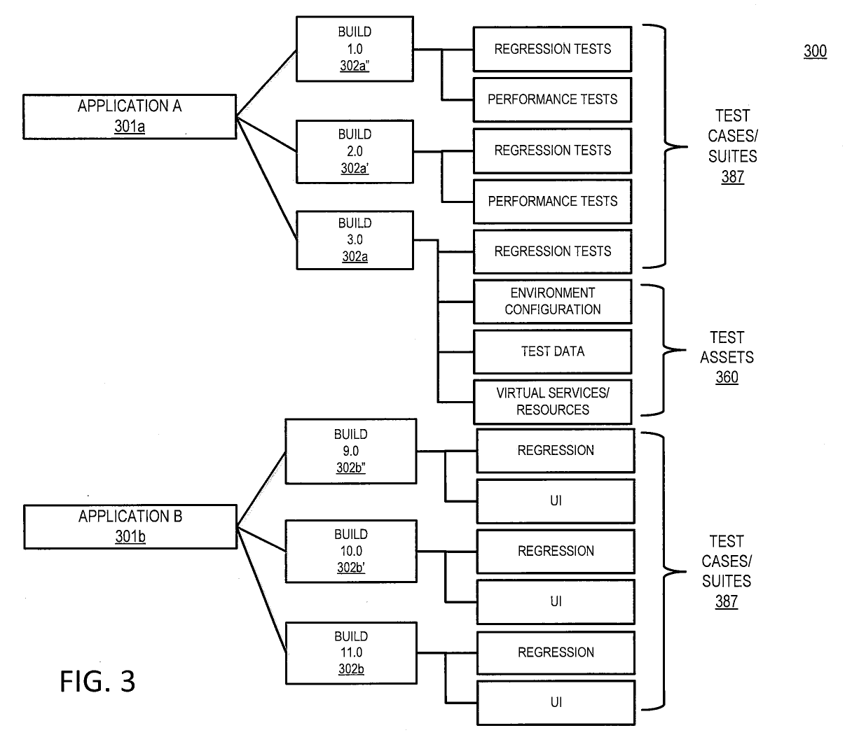

FIG. 2 is a simplified block diagram of an example computing system 200 including example implementations of the deployment automation system 105, server system 110 (illustrated as a build management system), application server 115, a test environment management system 120, test automation system 125, risk scoring system 130, and management devices 135, which are configured to perform automated environment provisioning, deployment, and testing of a build combination (e.g., build combination 102) according to some embodiments of the present disclosure. The build combination includes software artifacts (e.g., artifacts 104) of a specific software version to be deployed for testing.

The deployment automation system 105 is configured to perform automated deployment of a selected or requested build combination 102. The deployment automation system 105 can include at least one data processor 232, one or more memory elements 234, and functionality embodied in one or more components embodied in hardware- and/or software-based logic. For example, the deployment automation system 105 may include a deployment manager engine 236 that is configured to control automated deployment of a requested build combination 102 to a test environment based on a stored deployment plan or specification 240. The deployment plan 240 may include a workflow to perform the software deployment, including but not limited to configuration details and/or other associated description or instructions for deploying the build combination 102 to a test environment. Each deployment plan 240 can be reusable in that it can be used to deploy a corresponding build combination on multiple different environments. The deployment manager may be configured to deploy the build combination 102 based on the corresponding deployment plan 240 responsive to provisioning of the server(s) of the test environment with test assets selected for automated testing of the build combination 102.

The test environment management system 120 is configured to perform automated association of subset(s) of stored test assets with the test environment for the build combination 102, and automated provisioning of one or more servers of the test environment based on the associated test assets. The test environment management system 120 can include at least one data processor 252, one or more memory elements 254, and functionality embodied in one or more components embodied in hardware.- and/or software-based logic. For example, the test environment management system 120 may include an environmental correlation engine 256 that is configured to associate test assets stored in one or more databases 260 with the test environment for the selected build combination 102. The test assets may include environment resources 261, environment configuration attributes 262, and/or test data 263 that may be used for deployment and testing of software artifacts. The environment correlation engine 256 may be configured to select and associate one or more subsets of the test assets 261, 262, 263 (among the test assets stored in the database 260) with a test environment for a specific build combination 102, based on the modified software artifacts 104 thereof and/or risk scores associated therewith. The environment correlation engine 256 may be configured to select and associate the subsets of the test assets 261, 262, 263 based on code change analysis relative to an initial specification of relevant test assets for the respective software artifacts 104, for example, as represented by stored test logic elements 248.

The test environment management system 120 may further include an environment provisioning engine 258 that is configured to control execution of automated provisioning of one or more servers (e.g., application server 115) in the test environment based on the subset(s) of the test assets 261, 262, 263 associated with the test environment for a build combination 102. For instance, the associated subset(s) of test assets may identify and describe configuration parameters of an application server 115, database system, or other system. An application server 115 can include, for instance, one or more processors 266, one or more memory elements 268, and one or more software applications 269, including applets, plug-ins, operating systems, and other software programs and associated application data 270 that might be updated, supplemented, or added using automated deployment. Some software builds can involve updating not only the executable software, but supporting data structures and resources, such as a database.

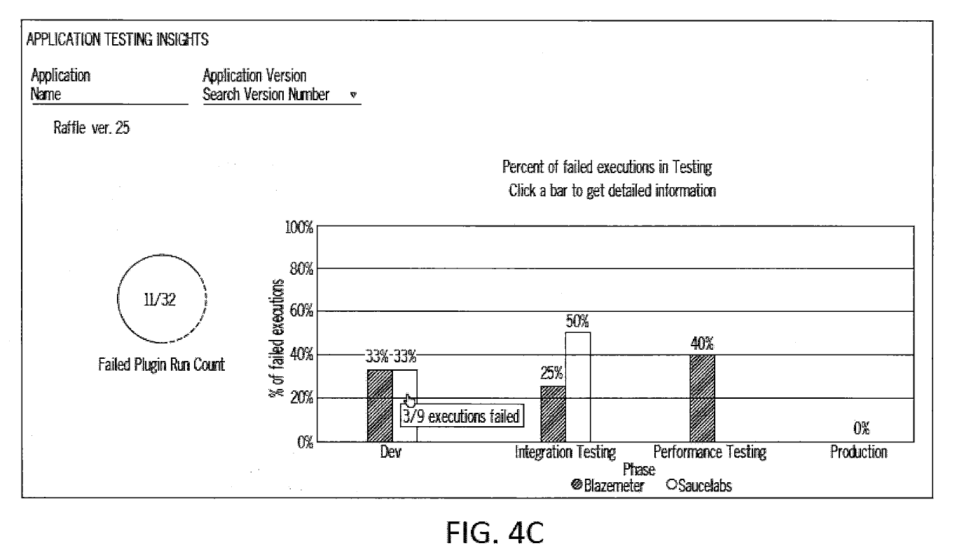

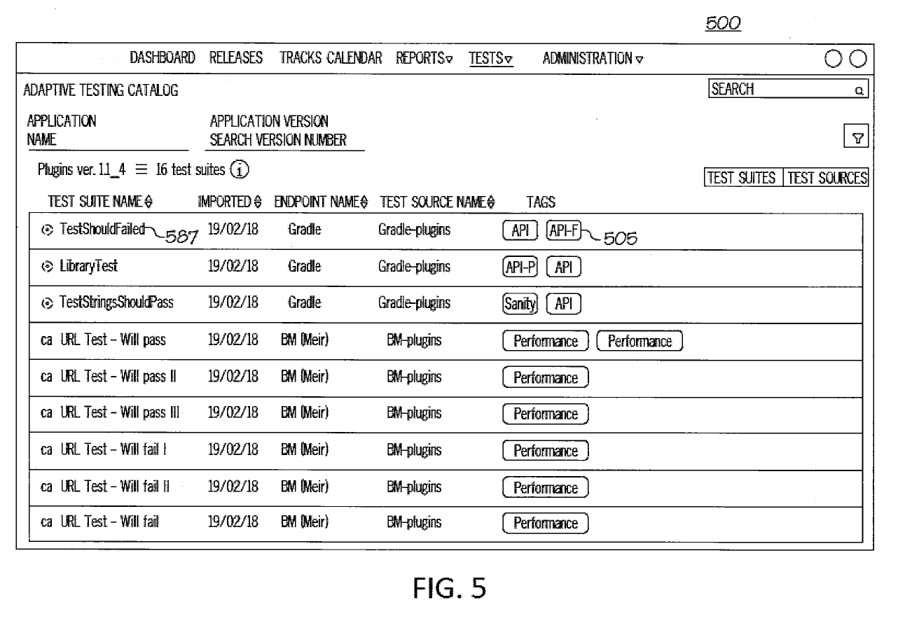

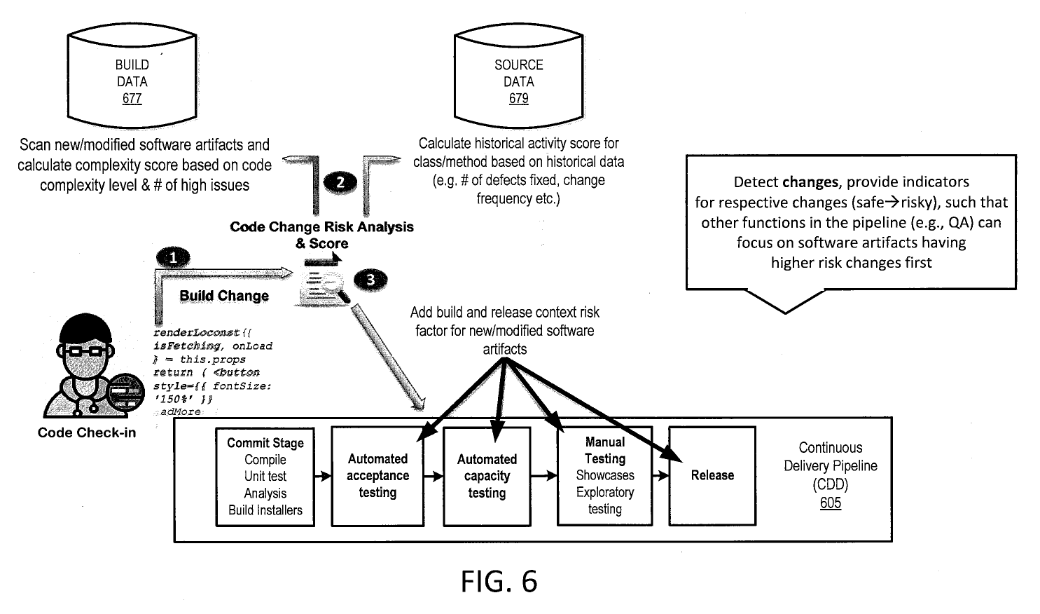

The build management system 110 may include one or more build data sources. A build data source can be a server (e.g., server 410 of FIG. 4A) including at least one processor device 262 and one or more memory elements 264, and functionality embodied in one or more components embodied in hardware- and/or software-based logic for receiving, maintaining, and providing various software artifacts of a requested or selected build combination 102 for deployment within the system. For example, the build management system 110 may include a build tracking engine 276 that is configured to track and store build data 277 indicating the various sets of software artifacts and modifications that are included in respective build combinations and changes thereto. The build management system may further include a source control engine 278 that is configured to track and commit source data 279 to a source repository 280. The source data 279 includes the source code, such as files including programming languages and/or object code, from which the software artifacts of a respective build combination are created. A development system may be used to create the build combination 102 and/or the software artifacts 104 from the source data 279, for example, using a library of development tools (e.g., compilers, debuggers, simulators and the like).

After a deployment is completed and the desired software artifacts are installed or loaded onto a one or more of the servers 115 of a test environment, it may be desirable to validate the deployment, test its functionality, or perform other post-deployment activities. Tools can be provided to perform such activities, including tools which can automate testing. For instance, a test automation system 125 can be provided that includes one or more processors 282, one or more memory elements 284, and functionality embodied in one or more components embodied in hardware- and/or software-based logic to perform or support automated testing of a deployed build combination 102. For example, the test automation system 125 can include a testing engine 286 that can initiate sample transactions to test how the deployed build combination 102 responds to the inputs. The inputs can be expected to result in particular outputs if the build combination 102 is operating correctly. The testing engine 286 can test the deployed software according to test cases 287 stored in a database 290. The test cases 287 may include particular types of testing (e.g., performance, UI, security, API, etc.), and/or particular categories of testing (e.g., regression, integration, etc.). The test cases 287 may be selected to define a test operation or test cycle that specifies how the testing engine 286 is to simulate the inputs of a user or client system to the deployed build combination 102. The testing engine 286 may observe and validate responses of the deployed build combination 102 to these inputs, which may be stored as test results 289.

The test automation system 125 can be invoked for automated test execution of the build combination 102 upon deployment to the application server(s) 115 of the test environment, to ensure that the deployed build combination 102 is operating as intended. As described herein, the test automation system 125 may further include a test correlation engine 288 that is configured to select and associate one or more subsets of test cases 287 with a test operation or test cycle for a build combination 102 selected for deployment (and/or the software artifacts 104 thereof). The subset(s) of the test cases 287 may be selected based on the modified software artifacts 104 included in the specific build combination 102 and/or risk scores associated therewith, such that the automated test execution by the testing engine 286 may execute a test suite that includes only some of (rather than all of) the database 290 of test cases 287.

The automated correlation between the test cases 287 and the modified software artifacts 104 performed by the test correlation engine 288 may be based on an initial or predetermined association between the test cases 287 and the software artifacts 104, for example, as provided by a developer or other network entity. For example, as software artifacts 104 are developed, particular types of testing (e.g., performance, UI, security, API, etc.) that are relevant for the software artifacts 104 may be initially specified and stored in a database. In some embodiments, these associations may be represented by stored test logic elements 248. Upon detection of modifications to one or more of the software artifacts 104, the test correlation engine 288 may thereby access a database or model as a basis to determine which test cases 287 may be relevant to testing the modified software artifacts 104. This initial correlation may be adapted by the test correlation engine 288 based, for example, on the interoperability of the modified software artifacts 104 with other software artifacts of the build combination 102, to select the subsets of test cases 287 to be associate with the modified software artifacts 104.

The test automation system 125 may also be configured to perform test case prioritization, such that higher-priority test cases 287 among a selected subset (or test suites including a higher-priority subset of test cases 287 among multiple selected subsets) are executed before lower-priority test cases or test suites. Selection and prioritization of test cases 287 by the test automation system 125 may be based on code change analysis, and further based on risk analysis, in accordance with embodiments described herein.

For example, still referring to FIG. 2, a risk scoring system 130 can include at least one data processor 292, one or more memory elements 294, and functionality embodied in one or more components embodied in hardware- and/or software-based logic. For instance, the risk scoring system 130 can include an analysis engine 296 and a risk score calculator 298, among potentially other components. The analysis engine 296 may be configured to perform an automated complexity analysis of the modified software artifacts 104 of a build combination 102 to generate complexity information 295, for example, indicative of interdependencies between the modified software artifact(s) 104 and the other software artifacts 104 of the build combination 102. The analysis engine 296 may be configured to perform an automated historical analysis on stored historical data for one or more previous versions of the build combination 102 (e.g., from the source data 279 in source repository 280) to generate historical activity information 297, for example, indicative of defects/corrections applied to the underlying object code or performance of the previous version(s). Risk scores 299 can be computed based on the complexity information 295 and/or the historical activity information 297 using the risk scoring system 130 (e.g., using score analysis engine 296 and score calculator 298). The risk scores 299 can be associated with a particular build combination 102 (referred to herein as a risk factor for the build combination 102), and/or to particular software artifacts 104 of the build combination 102, based on the amount, complexity, and/or history of modification thereof.

Although illustrated in FIG. 2 with reference to storage of particular data (test cases 287, test data 263, configuration data 262, resources data 261) in specific databases (e.g., 260, 290, etc.) that are accessible to particular systems 105, 110, 120, 125, 130, etc., it will be understood that these implementations are provided by way of example, rather than limitation. As a further example, in some embodiments the computing system 200 may include a data lake 275 and a test asset repository 285. The test asset repository 285 may be a storage repository or data store that holds data and/or references to the test cases 287, environment resources 261, environment configuration 262, and/or test data 263. The data lake 275 may be a storage repository or data store that holds data in native formats, including structured, semi-structured, and unstructured data, facilitating the collocation of data for various tasks of the computing system 200 in various forms. In some embodiments, the data lake 275 may store historical data (as used, for example, by the analysis engine 296 to generate the historical activity information 297) and data regarding test execution (as provided, for example, by testing engine 286), environment provisioning (as provided, for example, by environment provisioning engine 258), deployment activities (as provided, for example, by deployment manager 236), code modification for respective build combinations (as provided, for example, by build tracking engine 276), and risk scores (as provided, for example, by risk score calculator 298). The test asset repository 285 and data lake 275 may be accessible to one or more of the systems 105, 110, 120, 125, 130, etc. of FIG. 2, and thus, may be used in conjunction with or instead of the one or more of the respective databases 260, 290, etc. in some embodiments to provide correlation of environmental configuration, test cases, and/or risk assessment scoring as described herein. More generally, although illustrated in FIG. 2 with reference to particular systems and specific databases by way of example, it will be understood that the components and/or data described in connection with the illustrated systems and/or databases may be combined, divided, or otherwise organized in various implementations without departing from the functionality described herein.

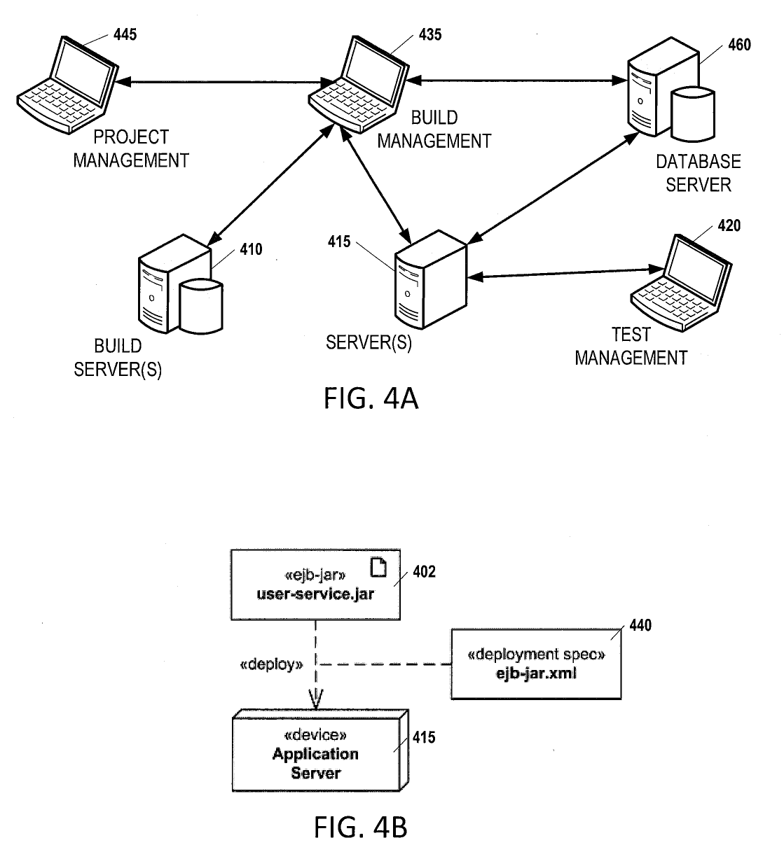

FIG. 2 further illustrates an example test logic engine 210 that includes at least one data processor 244, one or more memory elements 246, and functionality embodied in one or more components embodied in hardware- and/or software-based logic. For instance, the test logic engine 210 may be configured to define and generate test logic elements 248. The test logic elements 248 may include representations of logical entities, e.g., respective build combinations (including stories or use case descriptions, features of the application, defects, etc. that are part of each build combination), test cases and suites that may be relevant or useful to define test operations for the software artifacts of respective build combinations, and/or environment information that may be relevant or useful to set up the test operations for the software artifacts of the respective build combinations (including test data, virtual services, and environment configuration data). New or modified test logic elements 248 may be defined by selecting and associating combinations of test logic elements 248 representing build combinations, test assets, and test cases. Each test logic element 248, once defined and generated, can be made available for use and re-use in potential multiple different test environments corresponding to multiple different software deployments, as also described below with reference to the example model 300 of FIG. 3.

It should be appreciated that the architecture and implementation shown and described in connection with the example of FIG. 2 is provided for illustrative purposes only. Indeed, alternative implementations of an automated software deployment and testing system can be provided that do not depart from the scope of embodiments described herein. For instance, one or more of the illustrated components or systems can be integrated with, included in, or hosted on one or more of the same devices as one or more other illustrated components or systems. Thus, though the combinations of functions illustrated in FIG. 2 are examples, they are not limiting of the embodiments described herein. The functions of the embodiments described herein may be organized in multiple ways and, in some embodiments, may be configured without particular systems described herein such that the embodiments are not limited to the configuration illustrated in FIGS. 1A and 2. Similarly, though FIGS. 1A and 2 illustrate the various systems connected by a single network 170, it will be understood that not all systems need to be connected together in order to accomplish the goals of the embodiments described herein. For example, the network 170 may include multiple networks 170 that may, or may not, be interconnected with one another.

Some embodiments described herein may provide a central test logic model that can be used to manage test-related assets for automated test execution and environment provisioning, which may simplify test operations or cycles. The test logic model described herein can provide end-to-end visibility and tracking for testing software changes. An example test logic model according to some embodiments of the present disclosure is shown in FIG. 3. The model 300 may be configured to automatically adapt testing requirements for various different software applications, and can be reused whenever a new build combination is created and designated for testing. The model 300 includes representations of logical entities, such as those represented by the test logic elements 248 of FIG. 2.

Referring now to FIG. 3, the model 300 may include application elements 301a and 301b (collectively referred to as 301), which represent computer readable program code that provides a respective software application or feature (illustrated as Application A and Application B). More generally, the application elements 301 represent a logical entity that provides a system or service to an end user, for example, a web application, search engine, etc. The model 300 further includes build elements 302a, 302a′, 302a″ and 302b, 302b′, 302b″ (collectively referred to as 302), which represent build combinations corresponding to the application elements 301a and 301b, respectively (e.g., a specific version or revision of the Applications A and B). Each of the build elements 302 thus represent respective sets of software artifacts (including, for example, stories or use case descriptions, features of the application, defects, etc.) that may be deployed on a computing system as part of a respective build combination.

The model 300 may also include test case/suite elements 387 representing various test cases and/or test suites that may be relevant or useful to test the sets of software artifacts of the respective build combinations represented by the build elements 302. A test case may include a specification of inputs, execution conditions, procedure, and/or expected results that define a test to be executed to achieve a particular software testing objective, such as to exercise a particular program path or to verify compliance with a specific requirement. A test suite may refer to a collection of test cases, and may further include detailed instructions or goals for each collection of test cases and/or information on the system configuration to be used during testing. The test case/suite element 387 may represent particular types of testing (e.g., performance, UI, security, API, etc.), and/or particular categories of testing (e.g., regression, integration, etc.). In some embodiments, the test case/suite elements 387 may be used to associate and store different subsets of test cases with test operations for respective build combinations represented by the build elements 302.

The model 300 may further include test asset elements 360 representing environment information that may be relevant or useful to set up a test environment for the respective build combinations represented by the build elements 302. The environment information may include, but is not limited to, test data for use in testing the software artifacts, environment resources such as servers (including virtual machines or services) to be launched, and environment configuration attributes. The environment information may also include information such as configuration, passwords, addresses, and machines of the environment resources, as well as dependencies of resources on other machines. More generally, the environment information represented by the test asset elements 360 can include any information that might be used to access, provision, authenticate to, and deploy a build combination on a test environment.

In some embodiments, different build combinations may utilize different test asset elements 360 and/or test case/suite elements 387. This may correspond to functionality in one build combination that requires additional and/or different test asset elements 360 and/or test case/suite elements 387 than another build combination. For example, one build combination (for Application A) may require a server having a database, while another build combination (for Application B) may require a server having, instead or additionally, a web server. Similarly, different versions of a same build combination (e.g., as represented by build elements 302a, 302a′, 302a″) may utilize different test asset elements 360 and/or test case/suite elements 387, as functionality is added or removed from the build combination in different versions.

As illustrated in FIG. 3, the various elements 301, 302, 360, 387 of the test deployment model 300 may access, and be accessed by, various data sources. The data sources may include one or more tools that collect and provide data associated with the build combinations represented by the model 300. For example, the build management system 110 of FIG. 2 may provide data related to the build elements 302. Similarly, test automation system 125 of FIG. 2 may provide data related to test case and suite elements 387. Also, test environment management system 120 of FIG. 2 may provide data related to the test asset elements 360, and interdependencies therein. It will be understood that other potential data sources may be provided to automatically support the various data elements (e.g., 301, 302, 360, 387) of the test logic model 300. In some instances, creation and/or update of the various data elements (e.g., 301, 302, 360, 387) of the test logic model 300 may trigger, for example, automated test execution for a build combination and storing of performance data, without requiring access by a management device (e.g., 135, 145).

The use of a central model 300 may provide a reusable and uniform mechanism to manage testing of build combinations 302 and provide associations with relevant test assets 360 and test cases/suites 387. The model 300 may make it easier to form a repeatable process of the development and testing of a plurality of build combinations, both alone or in conjunction with code change analysis of the underlying software artifacts described herein. The repeatability may lead to improvements in quality in the build combinations, which may lead to improved functionality and performance of the resulting software release.

Computer program code for carrying out the operations discussed above with respect to FIGS. 1-3 may be written in a high-level programming language, such as COBOL, Python, Java, C, and/or C++, for development convenience. In addition, computer program code for carrying out operations of the present disclosure may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

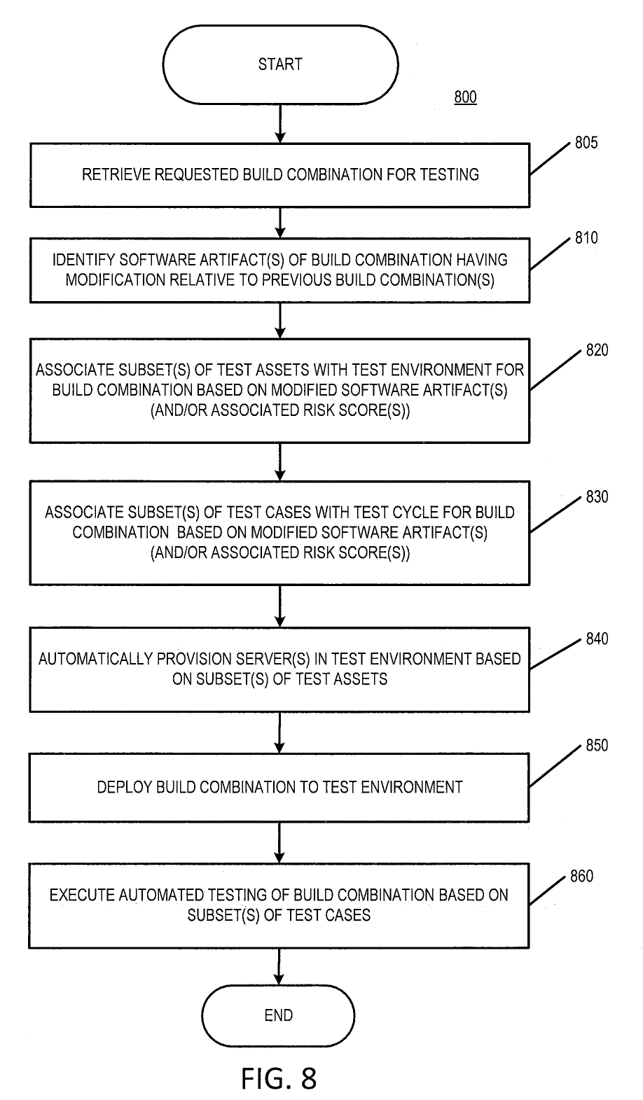

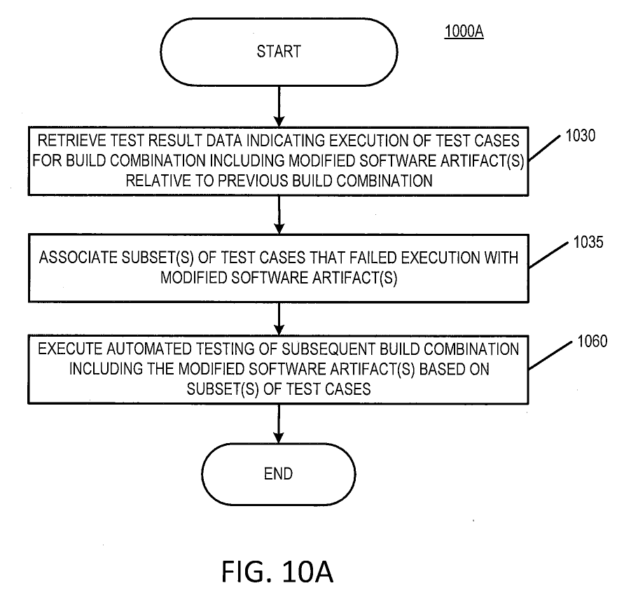

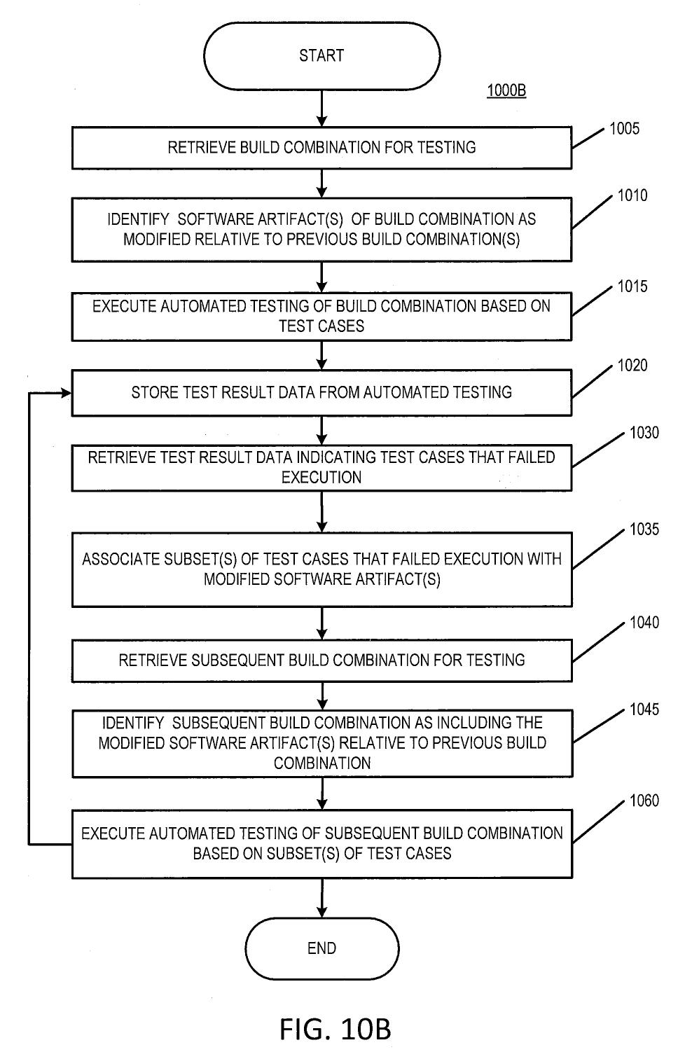

Operations for automated software test deployment and risk score calculation in accordance with some embodiments of the present disclosure will now be described with reference to the block diagrams of FIGS. 4A, 4B and 6, the screenshots of FIGS. 4C, 5, and 7, and the flowcharts of FIGS. 8 and 9. The operations 800 and 900 described with reference to FIGS. 8 and 9 may be performed by one or more elements of the system 200 of FIG. 2, the computing environment 100 of FIG. 1, and/or sub-elements thereof. Although not illustrated, communication between one or more elements of FIGS. 4A, 4B, and 6 may be implemented using one or more wired and/or wireless public and/or private data communication networks.

Referring now to FIG. 4A and FIG. 8, operations 800 begin at block 805 where a build combination for testing is retrieved. For example, a project management system 445 may transmit a notification to a build management system 435 including a version number of the build combination, and the build management system 435 may fetch the build combination (e.g., build combination 102) from the build server 410 based on the requested version number. At block 810, one or more software artifacts of the retrieved build combination may be identified as including changes or modifications relative to one or more previous build combinations. For example, the build management system 435 may automatically generate a version comparison of the retrieved build combination and one or more of the previous build combinations. The version comparison may indicate or otherwise be used to identify particular software artifact(s) including changes or modifications relative to the previous build combination(s). The comparison need not be limited to consecutive versions; for example, if a version 2.0 is problematic, changes between a version 3.0 and a more stable version 1.0 may be identified. Other methods for detecting new or changed software artifacts (more generally referred to herein as modified software artifacts) may also be used.

At block 820, one or more subsets of stored test assets (e.g., test assets 261, 262, 263) may be associated with a test environment for the retrieved build combination, based on the software artifact(s) identified as having the changes or modifications, and/or risk score(s) associated with the software artifact(s). For example, for each software artifact identified as having a change or modification, a risk score may be computed based on complexity information and/or historical activity information for the modified software artifact, as described by way of example with reference to FIG. 9. A subset of the stored test assets may thereby be selected as may be required for testing the modified software artifact, and/or as may be warranted based on the associated risk score. Also, at block 830, a subset of stored test cases (e.g., test cases 287) may be associated with a test operation or test cycle for the retrieved build combination, likewise based on the software artifact(s) identified as having the changes modifications and/or the associated risk score(s). For example, the subset of test assets and/or test cases may be selected based on identification of classes and/or methods of the modified software artifact(s), for instance based on tags or identifiers indicating that particular test assets and/or test cases may be useful or desirable for testing the identified classes and/or methods.

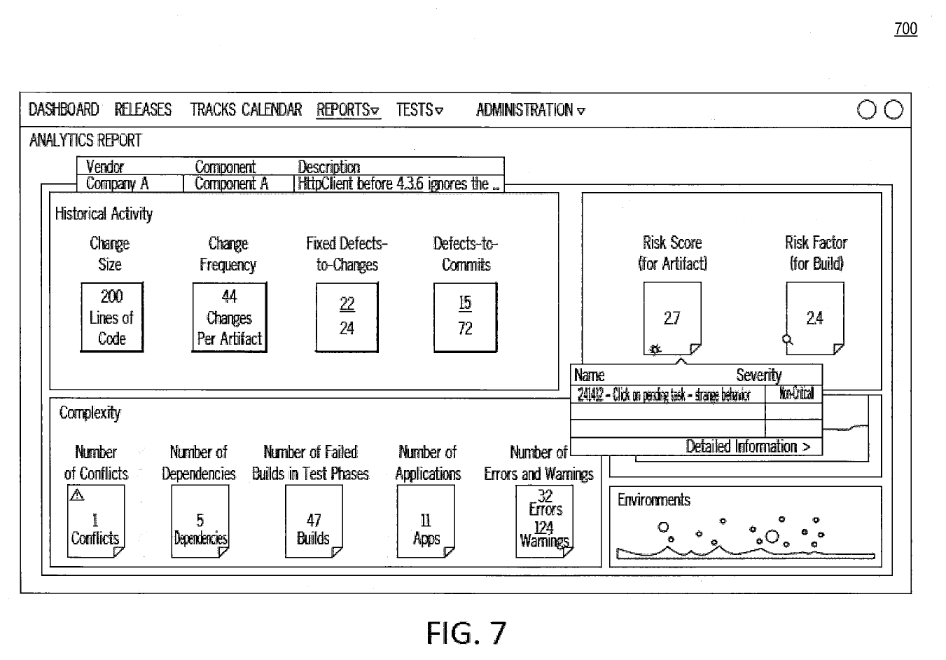

For example, FIG. 5 illustrates a screenshot of an example adaptive testing catalog user interface 500 including a listing of a subset of test suites 587 associated with the modified software artifacts of a retrieved build combination. The test assets and/or test cases may be stored in one or more database servers (e.g., database server 460 in FIG. 4A). As shown in FIG. 5, test cases and/or suites may be provided with tags 505 indicating particular types of testing (e.g., performance, UI, security, API, etc.), and the subset of test cases and/or particular test suites may be associated with the modified software artifacts based on the tags 505.

At block 840, one or more servers in the test environment may be automatically provisioned based on the subset(s) of the test assets associated with the requested build combination. For example, for the requested build combination version, subsets of test assets may be retrieved from the test assets database (e.g., database 260) or model (e.g. element 360) including, but not limited to, environment configuration data (e.g., data 262) such as networks, certifications, operating systems, patches, etc., test data (e.g., data 263) that should be used to test the modified software artifact(s) of the build combination, and/or environment resource data (e.g., data 261) such as virtual services that should be used to test against. One or more servers 415 in the test environment may thereby be automatically provisioned with the retrieved subsets of the test assets to set up the test environment, for example, by a test environment management system (e.g., system 120).

The automatic provisioning and/or test operation definition may include automatically removing at least one of the test assets from the test environment or at least one of the test cases from the test cycle in response to association of the subset(s) of the test assets (at block 820) or the test cases (at block 830), thereby reducing or minimizing the utilized test assets and/or test cases based on the particular modification(s) and/or associated risk score(s). That is, the test environment and/or test cycle can be dynamically limited to particular test assets and/or test cases that are relevant to the modified software artifacts as new build combinations are created, and may be free of test assets and/or test cases that may not be relevant to the modified software artifacts. Test environments and/or test cycles may thereby be narrowed or pared down such that only the new or changed features in a build combination are tested.

Referring now to FIG. 4B and FIG. 8, in response to the automated provisioning of the server(s) 415, a retrieved build combination 402 (illustrated as a Java archive (.jar) file) may be deployed to the test environment at block 850. For example, a deployment plan or specification 440 may be generated by a deployment automation system (e.g., system 105), and the build combination 402 may be deployed to an application server 415 in the test environment in accordance with the deployment plan 440. The deployment plan 440 may include configuration details and/or other descriptions or instructions for deploying the requested build combination 402 on the server 415. The deployment plan 440, once defined, can be reused to perform the same type of deployment, using the same defined set of steps, in multiple subsequent deployments, including deployments of various different software artifacts on various different target systems. Further, the deployment plans can be built from pre-defined tasks, or deployment steps, that can be re-usably selected from a library of deployment tasks to build a single deployment logic element for a given type of deployment. In some embodiments, the build combination 402 may be deployed to a same server 415 that was automatically provisioned based on the subset(s) of test assets associated with testing the modified software artifact(s) of the build combination 402, or to a different server in communication therewith.

Still referring to FIG. 4B and FIG. 8, automated testing of the retrieved build combination 402 is executed based on the associated subset(s) of test cases in response to the automated deployment of the build combination to the test environment at block 860. For example, after deployment is completed and the application server 415 in the test environment is set-up, a testing cycle or operation may be initiated by a test automation system (e.g., system 125). Tests may be executed based on the deployment plan 440 and based on the changes/modifications represented by the software artifacts of the deployed build combination 402. In some embodiments, an order or priority for testing the software artifacts of the build combination 402 may be determined based on the respective risk scores associated therewith. That is, for a given build combination, software artifacts that are associated with higher risk scores may be tested prior to and/or using more rigorous testing (in terms of selection of test cases and/or test assets) than software artifacts that are associated with lower risk scores. As such, higher-risk changes to a build combination can be prioritized and addressed, for example, in terms of testing order and/or allocation of resources.

Performance data from the automated testing of the build combination based on the selected subsets of the test assets and test cases may be collected and stored as test results (e.g., test results 289). The test results may be analyzed to calculate a quality score for the deployed build combination (e.g. by system 155). For example, as shown in FIG. 4C, an information graphic 400 illustrating failed executions resulting from a test operation including the selected subsets of test cases associated with a build combination may be generated and displayed, for example on a management device (e.g., client devices 135, 145). The test failures may include failed executions with respect to plug-in run count, development operations, integration testing, and/or performance testing. In some embodiments, the quality score may be used as a criteria as to whether the build combination is ready to progress to a next stage of a release pipeline, e.g., as part of an automated approval process to transition the build combination from the automated testing stage to a release stage. Embodiments described herein may allow for the automatic promotion of a build combination between phases of a release cycle based on data gathering and analysis techniques. Methods for automated monitoring and release of software artifacts are discussed in U.S. patent application Ser. No. 15/935,607 to Scheiner et al. entitled “AUTOMATED SOFTWARE RELEASE DISTRIBUTION”, the contents of which are herein incorporated by reference.

Generation of risk scores for the modified software artifacts of a retrieved build combination is described in greater detail with reference to FIGS. 6 and 9. As discussed above, in some embodiments, the risk score or assessment may be based on a complexity of the particular software artifacts including the changes/modifications, and on historical activity for the particular software artifacts including the changes/modifications. That is, the risk score or assessment may be based on automated analysis of past and present changes to a software artifact as indicators of risk. The risk analysis or assessment may be performed by a risk scoring system (e.g., system 130).

Referring now to FIG. 6 and FIG. 9, operations 900 begin at block 910 where build data 677 is accessed to retrieve a build combination (e.g., build combination 102), and one or more software artifacts (e.g., artifacts 104) of the build combination that have been modified relative to one or more other build combinations (e.g., build combinations 102′ or 102″) are detected (e.g., by build tracking engine 276). For a respective software artifact detected as being modified at block 910, an automated complexity analysis may be performed at block 920 (e.g., by analysis engine 296). For example, a modified software artifact may be scanned, and complexity information for the modified software artifact may be generated and stored (e.g., as complexity information 295) based on a level of code complexity and/or an amount or quantity of issues associated with the modification. In some embodiments, the complexity of a modified software artifact may be determined by analyzing internal dependencies of code within its build combination 102. A dependency may occur when a particular software artifact 104 of the build combination 102 uses functionality of, or is accessed by, another software artifact 104 of the build combination 102. In some embodiments, the number of dependencies may be tracked as an indicator of complexity. Code complexity information of a software artifact may be quantified or measured as a complexity score, for example, using SQALE analysis, which may analyze actual changes and/or defect fixes for a software artifact to output complexity information indicating the quality and/or complexity of the changed/modified software artifact.

Likewise, for a respective software artifact detected as being modified at block 910, an automated historical analysis of stored historical data for one or more previous versions of the modified software artifact (or a reference software artifact, such as a software artifact corresponding to a same class and/or method) may be performed at block 930 (e.g., by analysis engine 296). For example, historical activity information for the modified software artifact may be generated and stored (e.g., as historical activity information 297) from the automated historical analysis of stored historical data. The historical data may be stored in a database (e.g., database 280), and/or derived from data 679 stored in a source repository in some embodiments. The historical activity information for a software artifact may be quantified or measured as a historical activity score, for example, based on an amount/size and/or frequency of previous changes/modifications to that particular software artifact and/or to another reference low-risk software artifact, for example, an artifact in the in the same class or associated with a corresponding method. Historical activity for a software artifact may also be quantified or measured based on calculation of a ratio of changes relating to fixing defects versus overall changes to that particular software artifact. Changes relating to fixing defects may be identified, for example, based on analysis of statistics and/or commit comments stored in a source repository (e.g., using github, bitbucket, etc.), as well as based on key performance indicators (KPIs) including but not limited to SQALE scores, size of changes, frequency of changes, defect/commit ratio, etc.

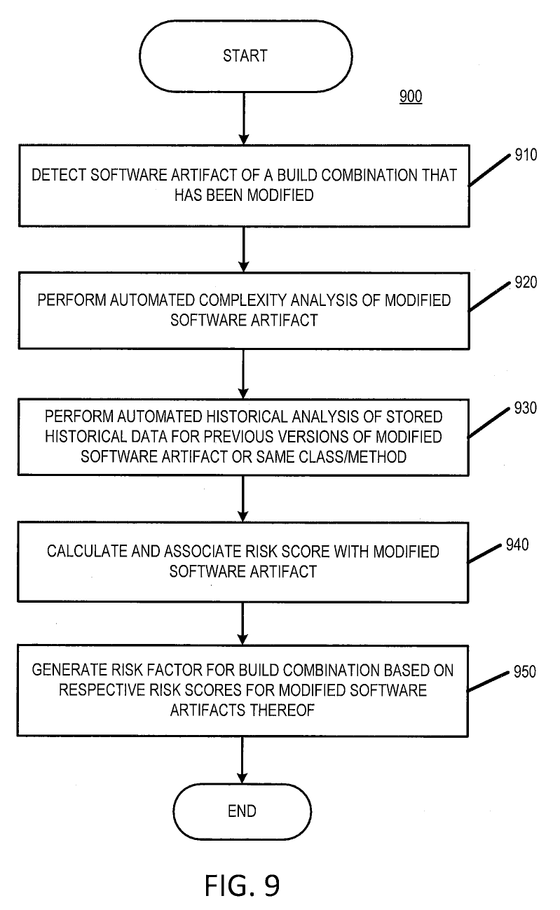

Measurements generated based on the modifications to the respective software artifacts of the build combination may be used to calculate and associate a risk score with a respective modified software artifact at block 940. The risk score is thus a measure that recognizes change complexity and change history as indicators of risk. An output such as alarm/flag and/or a suggested prioritization for testing of the code may be generated based on the risk score. For example, FIG. 7 illustrates a screenshot of an example analytics report user interface 700 displaying a risk score for a software artifact calculated based on complexity (e.g., number of conflicts, number of dependencies, number of failed builds in test phases, number of applications, and number of errors and warnings) and historical activity information (e.g., change size in lines of code, change frequency, corrected defects-to-changes, defects-to-commits). An overall risk factor for the collection or set of software artifacts of the build combination is also presented. In some embodiments, hovering or otherwise interacting with a particular icon may provide additional drilldown information that may provide additional data underlying the information in the icon.

The risk score may be used in accordance with embodiments of the present disclosure to provide several technical benefits to computing systems. For example, as discussed herein, the calculated risk score for a respective software artifact may be used for selection and association of test cases and/or test assets. More particularly, for a build combination under test, the risk score may assist in determining where relative risk lies among the modified software artifacts thereof. A testing priority in the automated testing may be determined among the set of software artifacts of the build combination based on the risk assessment or risk score, such that testing of particular artifacts may be prioritized in an order that is based on the calculated risk for the respective artifacts. Also, where a particular artifact includes multiple modifications, testing of particular modifications within a particular artifact may be prioritized in an order that is based on the calculated risk for the respective modifications.

Automated test case selection (and likewise, associated test asset selection) based on risk scores may thereby allow software artifacts associated with higher risk scores to be tested prior to (e.g., by altering the order of test cases) and/or using more rigorous testing (e.g., by selecting particular test cases/test assets) than software artifacts that are associated with lower risk scores. Higher-risk changes to a build combination can thereby be prioritized and addressed, for example, in terms of testing order and/or allocation of resources, ultimately resulting in higher quality of function in the released software. Conversely, one or more pre-existing (i.e., existing prior to identifying the software artifact having the modification) test assets and/or test cases may be removed from a test environment and/or test cycle for lower-risk changes to a build combination, resulting in improved testing efficiency. That is, the test environment and test cycle may include only test assets and/or test cases that are relevant to the code modification (e.g., using only a subset of the test assets and/or test cases that are relevant or useful to test the changes/modifications), allowing for dynamic automated execution and reduced processing burden.

In addition, the risk score may also allow for the comparison of one build combination to another in the test environment context. In particular, an order or prioritization for testing of a particular build combination (among other build combinations to be tested) may be based on computing a release risk assessment that is determined from analysis of its modified software artifacts. For example, an overall risk factor may be calculated for each new build combination or version based on respective risk assessments or risk scores for the particular software artifacts that are modified, relative to one or more previous build combinations/versions at block 950. In some embodiments, the risk factor for the build combination may be used as a criteria as to whether the build combination is ready to progress or be shifted to a next stage of the automated testing, and/or the number of resources to allocate to the build combination in a respective stage. For example, in a continuous delivery pipeline 605 shown in FIG. 6, the risk factor for the build combination may be used as a priority indicator in one or more subsequent automated evaluation steps (e.g., acceptance testing, capacity testing, etc.), such that additional resources are allocated to testing build combinations with higher risk factors. Also, a priority of the build combination in a subsequent automated evaluation may be based on the risk factor, e.g., compared to a risk factor of the second build combination, or to a reference risk value.

Embodiments described herein can thus provide an indication and/or quantification of risk for every software artifact that is changed and included in a new build or release, as well as for the overall build combination. These respective risk indications/quantifications may be utilized by downstream pipeline analysis functions (e.g., quality assessment (QA)) to focus on or otherwise prioritize higher-risk changes first. For example, automated testing of software artifacts as described herein may prioritized in an order that is based on the calculated risk score for particular artifacts and/or within a particular artifact for particular changes therein, such that higher-risk changes can be prioritized and addressed, for example, in terms of testing order and/or allocation of resources.

In addition, the paring-down of test assets and/or test cases for a build combination under test in accordance with embodiments described herein may allow for more efficient use of the test environment. For example, automatically removing one or more test cases from the test cycle for the build combination under test may allow a subsequent build combination to be scheduled for testing at an earlier time. That is, a time of deployment of another build combination to the test environment may be advanced responsive to altering the test cycle from the build combination currently under test. Similarly, an order of deployment of another build combination to the test environment may be advanced based on a test asset commonality with the subset of the test assets associated with the test environment for the build combination currently under test. That is, a subsequent build combination that may require some of the same test assets for which the test environment has already been provisioned may be identified and advanced for deployment, so as to avoid inefficiencies in re-provisioning of the test environment.

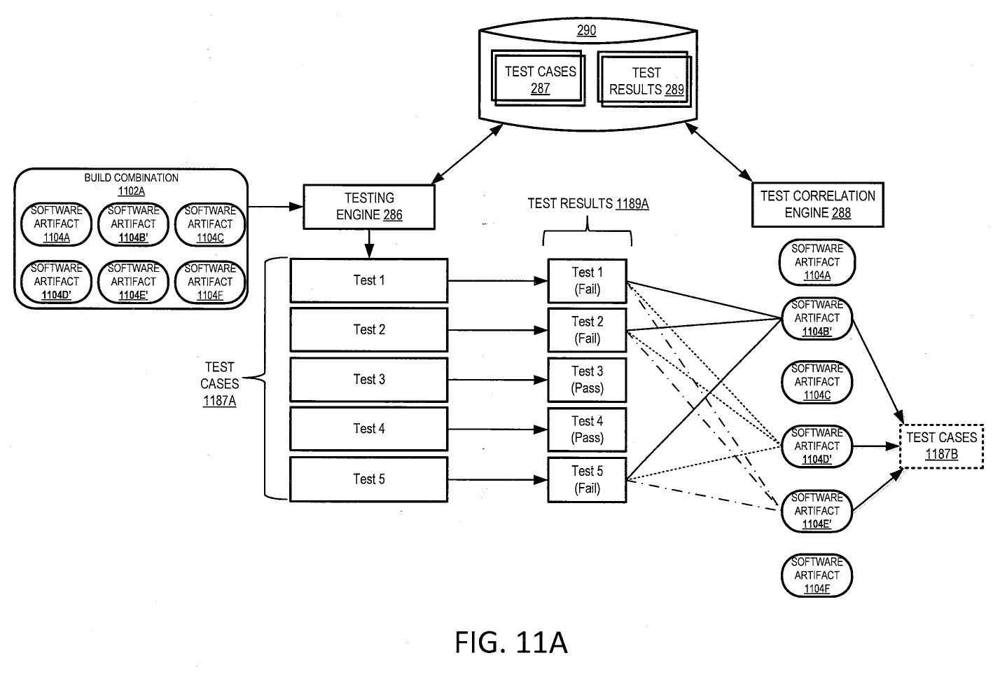

Further embodiments of the present disclosure are directed to operations for automatically paring-down automated test execution by associating failed test cases for a current build combination with software artifact(s) of the current build combination that have been modified relative to one or more previous build combinations. FIG. 10A is a simplified flowchart illustrating example operations 1000A for such paring-down of test cases for automated test execution. As shown in FIG. 10A, test result data (such as the test result data 289 of FIG. 2) indicating execution of a set of test cases (such as the test cases 287) for a build combination is retrieved from a data store (such as the database 290) at block 1030. The build combination includes at least one software artifact that has been modified (e.g., new or changed) relative to one or more previous build combinations. The test result data further indicates one or more of the set of test cases that failed execution for the build combination. The failed executions may include test case failures with respect to particular types of testing (e.g., performance, UI, security, API, etc.), and/or particular categories of testing (e.g., regression, integration, etc.).

Still referring to FIG. 10A, at block 1035, a subset including test cases that failed execution for the build combination are associated with the software artifact(s) thereof that have been modified, for example, based on a presumption that such modifications may have affected interoperability among the software artifacts (and thus contributed to the test case failures). At block 1060, automated testing of a subsequent build combination that includes the modified software artifact(s) is thus executed using or otherwise based on the subset including the test cases that failed execution for the previous build combination. The subset including the failed test cases may be a proper subset that omits at least one of the set of test cases, thereby reducing the amount of test cases for the automated testing of the subsequent build combination (and thus, associated computer processing requirements and duration for test cycle execution). That is, the failed test cases are attributed to the modified software artifact(s) as a starting point for reducing the testing for the subsequent build. The operations 1000A may be recursively performed such that the number of test cases is iteratively reduced for each subsequent build combination.

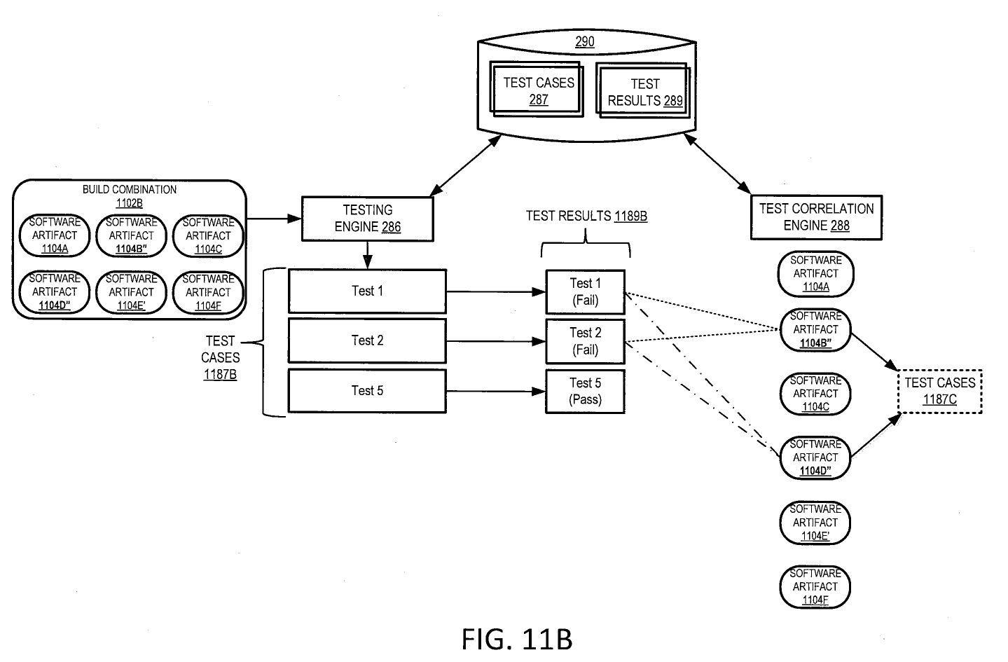

FIG. 10B is a flowchart illustrating operations 1000B for automatically paring-down automated test execution in greater detail. FIGS. 11A and 11B are block diagrams illustrating an example automated test case selection model based on code change analysis and failure correlation according to some embodiments of the present disclosure. The operations 1000B of FIG. 10B will be described with reference to the block diagrams of FIGS. 2, 11A, and 11B. Although described primarily with reference to selecting and associating a single subset of test cases based on detection of modification(s) relative to a previous build combination 1102A, it will be understood that code change analysis of a subsequent build combination 1102B relative to multiple build combinations may be similarly and concurrently performed, resulting in selection of multiple subsets of test cases (and thus, a test suite including the multiple subsets of test cases) for the automated testing of build combination 1102B. That is, the test suite for build combination 1102B may be selected based on comparison with not only build combination 1102A, but other previous build combinations, and the test suite may thus include not only subset 1187B, but multiple subsets of test cases.

Referring now to FIGS. 2, 10B and 11A, a build combination 1102A is retrieved for testing at block 1005. The build combination 1102A includes software artifacts 1104A, 1104B′, 1104C, 1104D′, 1104E′, and 1104F. Software artifacts 1104B′, 1104D′, and 1104E′ are identified as including modifications relative to one or more previous build combinations at block 1010. For example, software artifact 1104B′ may be a method that has been modified at the source code level (e.g., in the source data 279 of FIG. 2) to add features to and/or correct defects relative to a previous build combination. As discussed above, modified software artifacts of respective builds may be identified and tracked using a build tracking engine 278 that is configured to track and store build data 277 indicating the various sets of software artifacts and modifications that are included in respective build combinations and changes thereto, which may be stored in repository 280.

The build combination 1102A may be deployed to a test environment, and automated testing of the build combination 1102A may be executed based on a set of test cases 1187A at block 1015. For example, the testing engine 286 of the test automation system 125 of FIG. 2B may access the test cases 287 stored in database 290 to retrieve a set of test cases 1187A and execute the automated testing of the build combination 1102A based on the set of test cases 1187A. The test cases 287 may include particular types of testing (e.g., performance, UI, security, API, etc.), and/or particular categories of testing (e.g., regression, integration, etc.). The test cases 1187A may be selected to define a test operation or test cycle that specifies how the testing engine 286 is to simulate the inputs of a user or client system to the deployed build combination 1102A. In the example of FIG. 11A, the set of test cases 1187A includes test cases Test 1-Test 5.

The set of test cases 1187A may be associated with one or more software artifacts of the build combination 1102A, for example, based on operations performed by the test correlation engine 288. In some embodiments, one or more of the test cases 1187A may be test cases that failed execution for one or more previous build combinations that included the software artifacts 104B, 104D, and 104E, and may be selected for the automated testing of the build combination 1102A by the testing engine 286 responsive to identification of the software artifacts 1104B′, 1104D′, and 1104E′as being modified relative to the previous build combination(s). For example test cases Test 2 and Test 5 of the test cases 1187A may have also failed execution for a previous build combination 102 including software artifact 104B, and the test correlation engine 288 may associate Tests 2 and 5 for automated testing of the build combination 1102A by the testing engine 286 based on identification of software artifact 1104B′ being modified relative to software artifact 104B of the previous build combination 102, e.g., as indicated by the build data 277 stored in the repository 280.

Test result data 1189A from the automated testing of the build combination 1102A based on the set of test cases 1187A is stored in a data store at block 1020, and test results data indicating the test cases that failed execution of the testing of the build combination 1102A are retrieved at block 1030. For example, the test result data 1189A may be stored among the test results 289 in the database 290 responsive to execution of the test cases 1187A by the testing engine 286, and the test results 1189A for the build combination 1102A may be retrieved from the database 290 by the test correlation engine 288. In the example of FIG. 11A, the test results 1189A indicate failure of Test 1, Test 2, and Test 5 for the build combination 1102A.

At block 1035, at least one subset 1187B of the test cases 1187A is associated with the software artifacts 1104B′, 1104D′, and 1104E′ that were identified as including modification relative to previous build combination(s). The subset 1187B includes ones of the test cases 1187A that failed execution for the first build combination 1102A, in this example, Test 1, Test 2, and Test 5. That is, based on identification of the software artifacts 1104B′, 1104D′, and 1104E′ of build combination 1102A as being modified relative to previous build combination(s) and based on the failures of the test cases Test 1, Test 2, and Test 5 in the automated testing of build combination 1102A, test correlation engine 288 may associate test cases Test 1, Test 2, and Test 5 with the modified software artifacts 1104B′, 1104D′, and 1104E′. This association is shown in FIG. 11A by the solid, dotted, and dashed lines between the test results 1189A and software artifacts 1104B′, 1104D′, and 1104E′, respectively. In other words, the test correlation engine 288 effectively attributes the failure of test cases Test 1, Test 2, and Test 5 to the modifications included in software artifacts 1104B′, 1104D′, and 1104E′. The subset 1187B may be a proper subset that omits at least one of the test cases 1187A, thereby reducing the number of test cases in a test suite for a subsequent build combination.

In some embodiments, the subset 1187B of the test cases 1187A may be further selected and associated with one or more of the modified software artifacts 1104B′, 1104D′, and 1104E′ based on code coverage data 1191, for example, as collected by the code coverage tool 1190 of FIG. 2. For example, if the code coverage data 1191 for the software artifact 1104B′ indicates that it was not tested in the execution of Test 5 of the test cases 1187A (for example, by correlation with respective timestamps or other temporal data, as described in U.S. patent application Ser. No. 16/049,161 entitled “AUTOMATED SOFTWARE DEPLOYMENT AND TESTING BASED ON CODE COVERAGE CORRELATION”, the entire contents of which are incorporated by reference herein), the test correlation engine 288 may not associate Test 5 with software artifact 1104B′ (and may thus omit Test 5 from the subset 1187B) despite the failure of Test 5. As such, automated test execution by the testing engine 286 for a subsequent build combination may be based on a test suite that is further reduced relative to the set of test cases 1187A based on a combination of test failure correlation and code coverage correlation.

Referring now to FIGS. 2, 10B, and 11B, a subsequent build combination 1102B is retrieved for testing at block 1040. In some embodiments, the subsequent build combination 1102B may be non-consecutive to the build combination 1102A, that is, there may be intervening build combinations that are deployed for testing between the testing of build combination 1102A and build combination 1102B. The build combination 1102B includes software artifacts 1104A, 1104B″, 1104C, 1104D″, 1104E′, and 1104F. Software artifact 1104E′ is identified as including modification relative to build combination 1102A, and software artifacts 1104B″ and 1104D″ are identified as including further modifications relative to build combination 1102A at block 1045, for example, using a build tracking engine 278 that is configured to track and store build data 277 in a manner similar to that discussed above. The retrieved build combination 1102B may be deployed to a test environment, for instance, responsive to automatically provisioning a test server based on test assets corresponding to the subset 1187B of the test cases. For example, the deployment automation system 105 of FIG. 2, may be configured to perform automated deployment of the selected or requested build combination 1102B based on a stored deployment plan or specification 240.

Automated testing of the build combination 1102B may be executed by the testing engine 286 based on the associated subset of test cases 1187B (including test cases Test 1, Test 2, and Test 5) that failed test execution for build combination 1102A, at block 1060. For example, the associations between the subset 1187B and the modified software artifacts 1104B′, 1104D′, and 1104E′ correlated by the test correlation engine 288 (at block 1035) may be represented by stored test logic elements 248, which may be accessed by the testing engine 286 as a basis to select the subset 1187B responsive to detection or identification of the software artifacts 1104B′, 1104D′, and 1104E′ (or further modifications thereof) in the build combination 1102B. As noted above, in the example of FIG. 11B, the build combination 1102B includes software artifact 1104E′ from build combination 1102A, and software artifacts 1104B″ and 1104D″ that include further modification relative to build combination 1102A. The testing engine 286 may thus execute automated testing of the subsequent build combination 1102B based on a test case subset 1187B that omits or otherwise includes fewer test cases than the set 1187A used for testing previous build 1102A, which may reduce test cycle duration and/or processing requirements.

Test result data 1189B from the automated testing of the build combination 1102B based on the set of test cases 1187B is thus stored in the data store at block 1020, retrieved to indicate failed test cases at block 1030, and a subset 1187C including the test cases that failed execution for build combination 1102B (test cases Test 1 and Test 2 in the example of FIG. 11B) are associated with the software artifacts 1104B″ and 1104D″ (shown by the dotted and dashed lines, respectively) that include further modification relative to build combination 1102A at block 1035. The subset 1187C may be a proper subset that omits at least one of the test cases 1187B, thereby iteratively reducing the number of test cases in a test suite for a subsequent build combination.

The testing engine 286 of the test automation system 125 may also be configured to perform test case prioritization, such that higher-priority test cases among a selected subset 1187B (or test suites including a higher-priority subset of test cases among multiple selected subsets) are executed before lower-priority test cases or test suites. Selection and prioritization of test cases among the subset 1187B by the test automation system 125 in accordance with embodiments described herein may be based on risk analysis with respect to the test cases and/or the modified software artifacts.

For example, for the selected subset 1187B, the testing engine 286 may be configured to prioritize the test cases Test 1, Test 2, and Test 5 based on risk associated therewith, such as respective confidence scores associated with one or more of the test cases in the subset 1187B. The confidence scores may be computed by the analysis engine 296 of the risk scoring system 130 of FIG. 2, and may be assigned and stored in the scores 299 such that lower confidence scores are associated with test cases that failed test execution for multiple build combinations. In particular, in the example above, test cases Test 2 and Test 5 of the test cases 1187B may have failed execution for not only build combination 1102A, but also for a previous build combination 102, one or more of which may be non-consecutive to build combination 1102B. Test 2 and Test 5 thus may be assigned lower confidence scores (based on a higher likelihood of failure) than Test 1, and may be executed before test case Test 1 in the execution of the test cases 1187B for build combination 1102B based on the lower confidence scores. That is, test cases among the subset 1187B that failed during test execution for both the build combination 1102A and one or more previous build combinations may be weighted or otherwise granted a higher priority in the testing of the build combination 1102B, driving faster test failure. The test result data 289 stored in the database 290 may include such historical test result data from multiple previous build combinations, and may be accessed by the testing engine 286 to determine testing priority among the tests of the subset 1187B.

In another example, the testing engine 286 may be configured to further prioritize the test cases Test 1, Test 2, and Test 5 based on respective risk scores associated with the software artifacts 1104A, 1104B″, 1104C, 1104D″, 1104E′, and 1104F of the build combination 1102B, in addition or as an alternative to the prioritization based on the risks associated with the test cases. For instance, the analysis engine 296 of the risk scoring system 130 of FIG. 2 may be configured to perform an automated complexity analysis of one or more of the software artifacts 1104A, 1104B″, 1104C, 1104D″, 1104E′, and 1104F of the build combination 1102B, for example, indicative of interdependencies between the modified software artifact(s) 1104B″ and 1104D″and the other software artifacts of the build combination 1102B, which may be stored as complexity information 295. The analysis engine 296 may (additionally or alternatively) be configured to perform an automated historical analysis on stored historical data for one or more previous versions of the modified software artifact(s) 1104B″ and 1104D″of the build combination 1102B (e.g., from the source data 279 in source repository 280), which may be stored as historical activity information 297, for example, indicative of defects/corrections applied to the underlying object code or performance of the previous version(s) of the modified software artifact(s) 1104B″ and 1104D″. The analysis engine 296 may thus identify more complex and/or more frequently-modified software artifacts of a build as being higher-risk.

As noted above, risk scores 299 can be computed based on the complexity information 295 and/or the historical activity information 297 using the risk scoring system 130 (e.g., using score analysis engine 296 and score calculator 298). The risk scores 299 can be associated with a particular build combination 1102B (also referred to herein as a risk factor for the build combination), and/or to particular software artifacts of the build combination 1102B, based on the amount, complexity, and/or history of modification of the software artifacts of the build combination 1102B. As such, for a given build combination 1102B, the subset(s) of test cases associated with software artifact(s) thereof having higher risk scores may be executed prior to subset(s) of test cases that are associated with software artifact(s) having lower risk scores.

Automated operations for correlating test case failures to new and/or changed software artifacts in accordance with embodiments described herein may be used to iteratively remove and/or prioritize one or more test cases of a test cycle in automated test execution for a build combination. Such paring-down of the test cases as described herein may thus reduce computer processing requirements, increase speed of test operation or test cycle execution, reduce risk by increasing the potential to fail earlier in the validation stages, and improve overall efficiency in the test stage of the release pipeline.

Embodiments described herein may thus support and provide for continuous testing scenarios, and may be used to test new or changed software artifacts more efficiently based on risks and priority during every phase of the development and delivery process, as well as to fix issues as they arise. Some embodiments described herein may be implemented in a release pipeline management application. One example software based pipeline management system is CA Continuous Delivery Director™, which can provide pipeline planning, orchestration, and analytics capabilities.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. As used herein, “a processor” may refer to one or more processors.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the FIGURES illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGURES. For example, two blocks shown in succession may, in fact, be executed substantially concurrently, or the blocks may sometimes be executed in the reverse order, depending upon the functionality involved. Although some of the diagrams include arrows on communication paths to show a primary direction of communication, it is to be understood that communication may occur in the opposite direction to the depicted arrows. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” (and variants thereof) when used herein, specify the presence of stated features, integers, steps, operations, elements, and/or components, but do not preclude the presence or addition of one or more other features, integers, steps, operations, elements, components, and/or groups thereof. In contrast, the term “consisting of” (and variants thereof) when used in this specification, specifies the stated features, integers, steps, operations, elements, and/or components, and precludes additional features, integers, steps, operations, elements and/or components. Elements described as being “to” perform functions, acts and/or operations may be configured to or otherwise structured to do so. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein.

Many different embodiments have been disclosed herein, in connection with the above description and the drawings. Other methods, systems, articles of manufacture, and/or computer program products will be or become apparent to one with skill in the art upon review of the drawings and detailed description. It is intended that all such additional systems, methods, articles of manufacture, and/or computer program products be included within the scope of the present disclosure. Moreover, it is intended that all embodiments disclosed herein can be implemented separately or combined in any way and/or combination. That is, it would be unduly repetitious and obfuscating to literally describe and illustrate every combination and subcombination of these embodiments, and accordingly, all embodiments can be combined in any way and/or combination, and the present specification, including the drawings, shall support claims to any such combination or subcombination.

In the drawings and specification, there have been disclosed typical embodiments and, although specific terms are employed, they are used in a generic and descriptive sense only and not for purposes of limitation, the scope of the disclosure being set forth in the following claims.

What is claimed is:

1. A method, comprising:
retrieving, from a data store, test result data indicating execution of a plurality of test cases for a first build combination, the first build combination comprising a software artifact comprising modification relative to a previous build combination;
associating a subset of the test cases with the software artifact based on the test result data, wherein the subset of the test cases comprises test cases that failed the execution of the test cases for the first build combination; and
executing automated testing of a second build combination comprising the software artifact, wherein the second build combination is subsequent and non-consecutive to the first build combination, and wherein the automated testing of the second build combination comprises the subset of the test cases.

2. The method of claim 1, further comprising:
identifying, among a set of software artifacts of the second build combination, the software artifact as comprising further modification relative to the first build combination; and
selecting the subset of the test cases for the automated testing responsive to the identifying, wherein the subset omits one of the test cases.

3. The method of claim 1, further comprising:
identifying, among a set of software artifacts of the first build combination, the software artifact relative to the previous build combination;
executing automated testing of the first build combination based on the plurality of test cases responsive to the identifying the software artifact to generate the test result data; and
storing the test result data in the data store, wherein the test result data indicates the test cases that failed the execution for the first build combination.

4. The method of claim 3, wherein the plurality of test cases comprises test cases that failed execution for the previous build combination.

5. The method of claim 4, wherein the executing the automated testing of the second build combination comprises:
prioritizing respective test cases among the subset of the test cases based on risk associated therewith.

6. The method of claim 5, wherein the prioritizing comprises prioritizing ones of the respective test cases that failed the execution for the first build combination and also failed the execution for the previous build combination.

7. The method of claim 3, wherein the first build combination is non-consecutive to the previous build combination.

8. The method of claim 1, further comprising:
retrieving code coverage data indicating execution of the software artifact during the plurality of test cases;
wherein the associating the subset of the test cases with the software artifact is further based on the code coverage data.

9. The method of claim 1, wherein the software artifact of the second build combination comprises a plurality of software artifacts, and further comprising:
prioritizing respective test cases among the subset of the test cases based on respective risk scores associated with the plurality of software artifacts of the second build combination.

10. The method of claim 9, wherein the respective risk scores are based on complexity information from an automated complexity analysis performed on the plurality of software artifacts of the second build combination.

11. The method of claim 10, wherein the complexity information comprises interdependencies between the plurality of software artifacts of the second build combination.

12. The method of claim 9, wherein the respective risk scores are based on historical activity information from an automated historical analysis performed on stored historical data for at least one previous version of each of the plurality of software artifacts of the second build combination.

13. The method of claim 1, wherein the operations further comprise:
automatically provisioning a server in a test environment based on test assets corresponding to the subset of the test cases; and
deploying the second build combination to the test environment responsive to the automatically provisioning the server.

14. A computer program product, comprising:
a tangible, non-transitory computer readable storage medium comprising computer readable program code embodied therein, the computer readable program code comprising:
computer readable code to retrieve, from a data store, test result data indicating execution of a plurality of test cases for a first build combination, the first build combination comprising a software artifact comprising modification relative to a previous build combination;
computer readable code to associate a subset of the test cases with the software artifact based on the test result data, wherein the subset of the test cases comprises test cases that failed the execution of the test cases for the first build combination; and
computer readable code to execute automated testing of a second build combination comprising the software artifact, wherein the second build combination is subsequent and non-consecutive to the first build combination, and wherein the automated testing of the second build combination comprises the subset of the test cases.

15. The computer program product of claim 14, further comprising:
computer readable code to identify, among a set of software artifacts of the second build combination, the software artifact as comprising further modification relative to the first build combination; and
computer readable code to select the subset of the test cases for the automated testing responsive to the computer readable code to identify, wherein the subset omits one of the test cases.

16. The computer program product of claim 14, further comprising:
computer readable code to identify, among a set of software artifacts of the first build combination, the software artifact thereof comprising modification relative to the previous build combination;
computer readable code to execute automated testing of the first build combination based on the plurality of test cases responsive to identification of the software artifact to generate the test result data; and
computer readable code to store the test result data in the data store, wherein the test result data indicates the test cases that failed the execution for the first build combination.

17. The computer program product of claim 16, wherein the plurality of test cases comprises test cases that failed execution for the previous build combination.

18. The computer program product of claim 17,wherein the computer readable code to execute the automated testing of the second build combination comprises:
computer readable code to prioritize respective test cases among the subset of the test cases based on risk associated therewith.

19. The computer program product of claim 18, wherein ones of the respective test cases that failed the execution for the first build combination and failed the execution for the previous build combination are prioritized.

20. A computer system, comprising:
a processor; and
a memory coupled to the processor, the memory comprising computer readable program code embodied therein that, when executed by the processor, causes the processor to perform operations comprising:
retrieving, from a data store, test result data indicating execution of a plurality of test cases for a first build combination, the first build combination comprising a software artifact comprising modification relative to a previous build combination;
associating a subset of the test cases with the software artifact based on the test result data, wherein the subset of the test cases comprises test cases that failed the execution of the test cases for the first build combination; and
executing automated testing of a second build combination comprising the software artifact, wherein the second build combination is subsequent and non-consecutive to the first build combination, and wherein the automated testing of the second build combination comprises the subset of the test cases.
